(19) United States
(12) Patent Application Publication
(10) Pub. No.: US 2014/0231600 A1
(43) Pub. Date: Aug. 21, 2014

(54) ADJUSTABLE SUPPORT STAND FOR AN ELECTRONIC DISPLAY DEVICE

(71) Applicant: Paul William Carmichael, Mill Bay (CA)

(72) Inventor: Paul William Carmichael, Mill Bay (CA)

(21) Appl. No.: 13/770,152

(22) Filed: Feb. 19, 2013

(51) Int. Cl. F16M 11/04

(52) U.S. Cl. CPC F16M 11/04
USPC 248/121

(57) ABSTRACT

Disclosed is an adjustable support stand for an electronic display device. The stand comprises a central hinge rod, a bottom receptacle for receiving a bottom edge of the device therewithin, the bottom receptacle hingedly coupled to the hinge rod, a rear leg member hingedly coupled to the hinge rod, a top receptacle for gripping over a top edge of the device, a string band for looping together the rear leg member and the top receptacle while abutting the front of the hinge rod and a locking device coupled to the string band for restricting and freeing the loop of the string band. Each of the three components, viz., the top and bottom receptacles and the leg member comprises a frame structure made from bending a pliable wire.

### BACKGROUND

The present invention relates to support devices and more particularly to an adjustable support stand for an electronic display device, such as, a tablet computer, e-book reader, etc.

Tablet computers and e-book readers are basically handheld devices and holding these devices for long periods of time is far from convenient. They can however be placed on surfaces, such as a tabletop, but, then again, that is not a generally desirable viewing angle. This exact need for a means for providing a convenient viewing angle led to the inception of support stands whereon, the device is propped at upright or close-to-upright positions. The market for tablet computers, and the like, is relatively young, and the market for the aforementioned support stands can only be relatively younger. Therefore, there is a lot of inventive space around for one to come up with new ideas concerning the support devices.

### SUMMARY

The present invention is an adjustable stand for an electronic display device. The stand comprises a hinge rod, a top and a bottom receptacle and a rear leg member wherein, the bottom receptacle and the rear leg member are hingedly coupled to the hinge rod. The top receptacle and the rear leg member are looped together by means of an elastic string band, which abuts the front of the hinge rod centrally as it extends between the top receptacle and the rear leg member. A locking device is used for restricting or increasing the loop of the elastic band. In order to use the stand, a display device is initially received within the bottom receptacle. Once there, the top receptacle is placed over the display device. The locking device is adjusted before or after the top receptacle is placed such that, the display device is firmly held between the top and bottom receptacles. Notably, the top and bottom receptacles and the rear leg member comprise frame structure, each made from a pliable wire.

Other objects and advantages of the embodiments herein will become readily apparent from the following detailed description taken in conjunction with the accompanying drawings.

### BRIEF DESCRIPTIONS OF THE DRAWINGS

FIG. 1 is a front perspective view of the adjustable support stand supporting an electronic display device according to the preferred embodiment of the present invention.

FIG. 2 is a rear perspective view of the adjustable support stand supporting an electronic display device according to the preferred embodiment of the present invention.

FIG. 3 is a side view of the adjustable support stand supporting an electronic display device according to the preferred embodiment of the present invention.

FIG. 4 is a view of the hinge rod according to the preferred embodiment of the present invention.

FIG. 5 is a view of the base rod according to the preferred embodiment of the present invention.

### FIGURES

### Reference Numerals

### 10 . . . Adjustable Support Stand

### 12 . . . Electronic Display Device

### 14 . . . Hinge Rod

### 16 . . . Bottom Receptacle

### 18 . . . Rear Leg Member

### 20 . . . Top Receptacle

### 22 . . . String Band/Elastic Ring

### 24 . . . Locking Device

### 26 . . . Base Rod

### 28 . . . Hinge Sleeve

### 30 . . . Wing-nut

### 32 . . . Central Section

### 34 . . . Hinge Section

### 36 . . . Threaded Portion

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

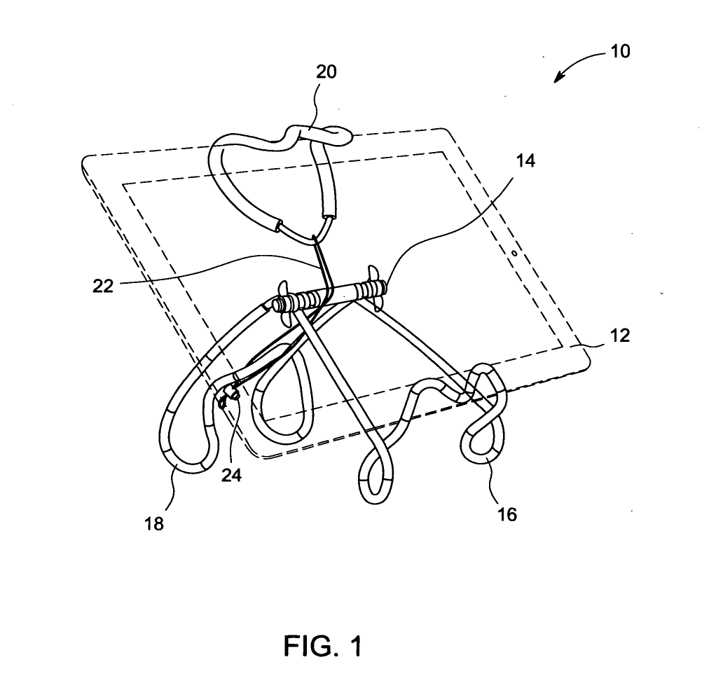

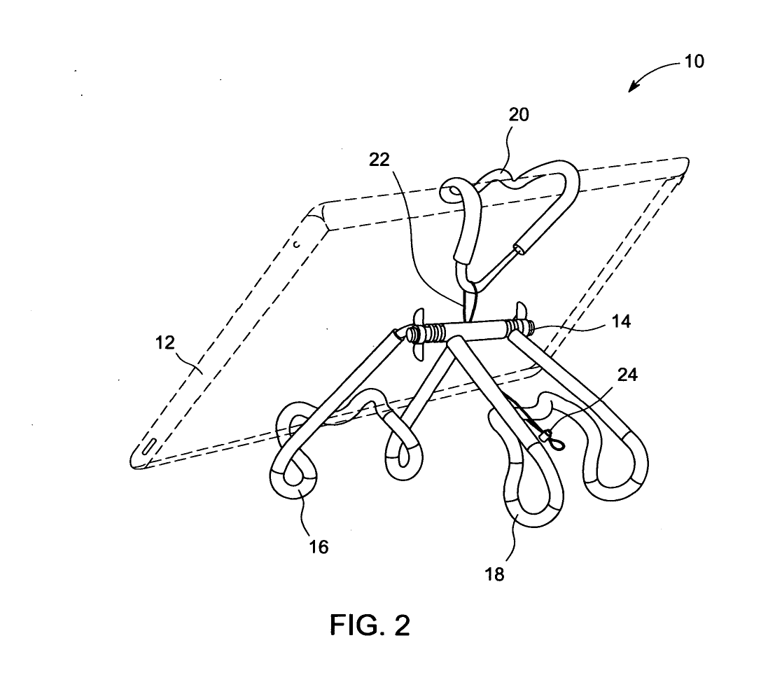

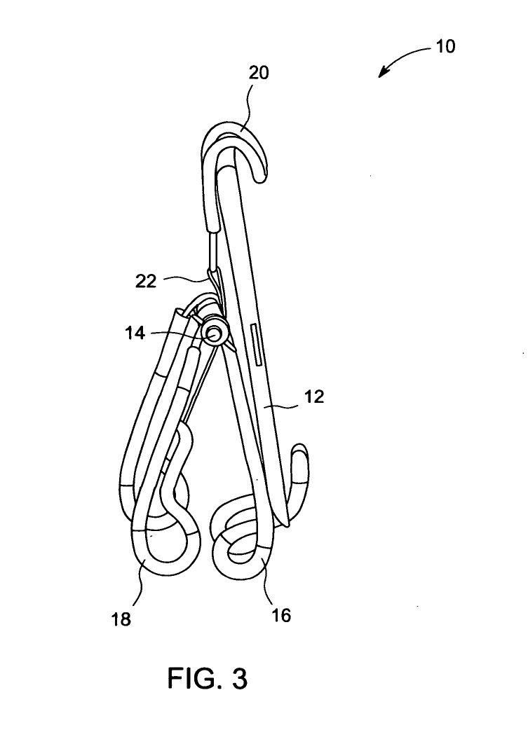

Referring to FIGS. 1 through 3, the present invention comprises an adjustable support stand 10 for supporting an electronic display device 12 such as, a tablet computer (Ex: Apple iPad®), e-book reader (Ex: Amazon Kindle®), and the like, in a viewable position, which generally is close-to-upright. The adjustable stand, as the term suggests, offers various ways of adjustability. One way of adjustability is, the stand 10 allows the display device 12 to be positioned at various viewing angles ranging from close-to-horizontal to almost upright. Another way of adjustability is, the stand 10 the display device 12 to be supported at landscape and portrait orientations with respect to the user. The stand 10 is also adjustable to accommodate the devices of various makes, models and sizes ranging from 5 to 11 inches. Most of the components of the stand 10 are made of a pliable material allowing the stand 10 to be adapted to be fitted over unconventional surfaces, such as over the thigh of the user. More on this will be discussed in the following body of text. Finally, the stand 10 is collapsible into a compact state when not in use, i.e., when not supporting a device.

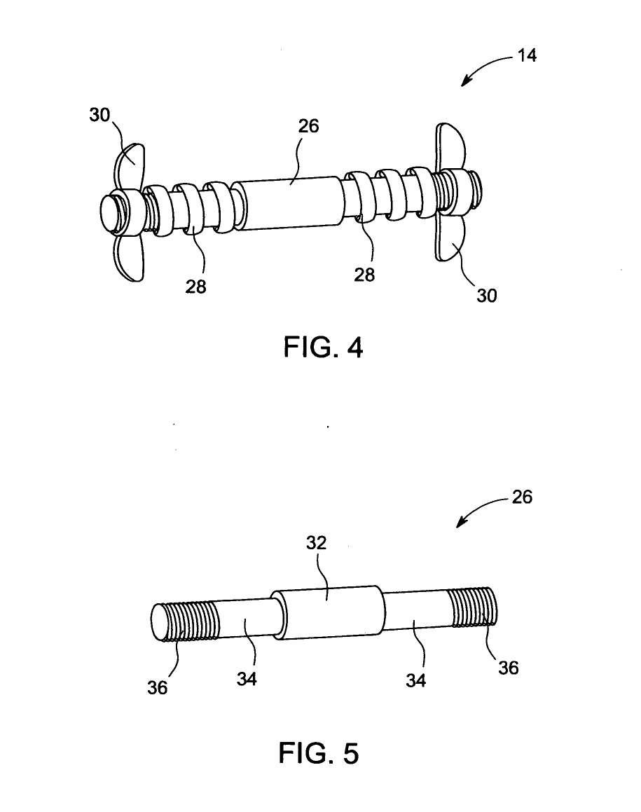

Still referring to FIGS. 1 through 3, the stand 10 is made up of components comprising a central hinge rod 14, a bottom receptacle 16, a rear leg member 18, a top receptacle 20, a string band 22, and a spring-enabled locking device 24. Now referring to FIGS. 4 and 5, the hinge rod 14 is also an assembly of various components comprising is a base rod 26, a pair of cylindrical hinge sleeves 28, and a pair of wing-nuts 30. The base rod 26 comprises an elongate cylindrical rod of non-uniform circular cross-section divided into a central section 32 and a pair of hinge sections 34 adjoining either side of the central section 32. The free end of each hinge section 34 terminates in a threaded portion 36, which is adapted to threadably receive a wing-nut 30. The cross-sectional area of the central section 32 is greater than that of the hinge sections 34. The hinge sleeve 28 basically comprises a helical compression spring. The inner cross-sectional diameter of the hinge sleeve 28 is marginally greater than the cross-sectional diameter of the hinge sections 34 allowing the hinge sleeve 28 to be snugly and slidably inserted into the hinge section 34. In order to assemble the hinge rod 14, the hinge sleeves 28 are inserted into the hinge sections 34 upon which, the wing-nuts 30 are threaded to the threaded portions 36 whereby, the hinge sleeves 28 are compressed between the central section 32 and the wing-nuts 30. As the wing-nuts 30 are loosened or tightened, the distance between two consecutive loops of the hinge sleeves are increased or decreased respectively. The aspect of controlling distance between two consecutive loops of the hinge sleeves 28 via the wing-nuts 30 is an important factor, which will be apparent from the following body of text.

The top and bottom receptacles, and the rear leg member are basically frame structures that are simple in construction made by bending a single elongate pliable wire or rod. The pliable wire is preferably a galvanized steel wire. Before a pliable wire being bent into one of the components, the pliable wire is inserted into a non-latex rubber tubing. The rubber tubing prevents any slippage between the adjustable stand and the surface (even a smooth surface) whereon the stand is placed. Yet another advantage is, the rubber tubing also cushions to the pliable wire in case of a fall or drop. The rubber tubing also cushions the device therewithin, and while doing so, doesn't scratch the device.

In order to make the bottom receptacle, initially, an elongate pliable wire (inserted into a tubing) is bent into a U-shape so as to form a pair of opposing side receptacle wire sections and a central receptacle wire section that joins the pair of side receptacle wire sections at the ends thereof. The free ends of the U-shaped wire are hingedly coupled to the pair of hinge sleeves by winding the free ends of the U-shaped wire between the loops of the hinge sleeves. More particularly, the hinge rod is disposed behind the U-shaped wire as the U-shaped wire is hingedly coupled to the hinge rod. Therefore, as the wing-nuts are loosened and tightened, the angular movement of the U-shaped wire relative to the hinge rod is loosened and tightened respectively. However, the U-shaped wire can be hingedly coupled to the hinge rod even at later stages of making the bottom receptacle. The U-shaped wire (coupled to the hinge rod) is held in the upright position and the bottom portion thereof is bent backwards to forwards till a pair of loops are formed and a portion of the bottom portion extends beyond the side receptacle wire sections as viewed from side. The pair of loops acts as a pair of front legs for the stand.

The portion the bottom portion that extends beyond the side receptacle wire sections is referred to as a projection portion. The projection portion is divided into a pair of opposing projection wire sections and a central receptacle wire section. The pair of projection wire sections is bent upwards such that, a U-shape is formed between a projection wire section and the corresponding side receptacle wire section as viewed from side. The mid section of the central receptacle wire section is bent downwards such that, the central receptacle wire section forms an M-shape or a claw shape as viewed from front. The bottom receptacle receives the display device as a bottom edge of the device is received within the U-shape formed between the pair of projected wire sections and the side receptacle wire sections. As the bottom receptacle is made of a pliable material, once the bottom edge of the device is received within the bottom receptacle, the pair of projected wire sections and the central receptacle wire section may be pressed against the device for a snug fit.

The initial step of making the rear leg member is similar to that of the bottom receptacle, which is to bend an elongate pliable wire (inserted into a tubing) into a U-shape resulting the formation of a pair of opposing side leg wire sections and a central leg wire section that joins the pair of side leg wire sections at the ends thereof. The free ends of the U-shaped wire are hingedly coupled to the pair of hinge sleeves by winding the free ends of the U-shaped wire between the loops of the hinge sleeves. More particularly, the hinge rod is disposed in front of the U-shaped wire as the U-shaped wire is hingedly coupled to the hinge rod. Therefore, as the wing-nuts are loosened and tightened, the angular movement of the U-shaped wire relative to the hinge rod is loosened and tightened respectively. However, the U-shaped wire can be hingedly coupled to the hinge rod even at later stages of making the rear leg member. The bottom portion of the U-shaped wire held in an upright position is bent forward and then upward such that, a pair of U-shapes is formed between the bent section of the U-shaped wire and the rest of the U-shaped wire as viewed from side. The pair of U-shapes acts another pair of hind legs for the stand. In one embodiment, the mid portion of the central wire section comprises a loop or the like, the object of which will be apparent from the following body of text. The length of the portion of the bottom receptacle that extends between the hinge rod and a ground contact point of a loop is substantially equivalent to that of a portion of the leg member that extends between the hinge rod and a ground point of contact of a U-shape of the pair of U-shapes.

The top receptacle is made by permanently joining the free ends of a pliable wire (inserted into a tubing) to form a circular ring divided into first and second circumferential sections. Once there, the first circumferential section is bent into a planar V-shape about a midpoint. With the ring is being held upright, with the V-shape forming bottom of the ring, the second circumferential section is bent forward or backward so as to form an inverted U-shape between the first and second circumferential sections as viewed from side. The midpoint of the second circumferential section is bent upwards so as to form a W-shape or a claw shape as viewed from front. A top edge of the device is received within the inverted U-shape formed between the first and second circumferential sections as the top receptacle is received over the device. As the top receptacle is made of a pliable material, once the top edge of the device is received within the top receptacle, the claw-shaped portion of the top receptacle may be pressed against the device for a snug fit.

Referring again to FIGS. 1 through 3, the top receptacle 20 is connected to the rear leg member 18 by means of the string band 22. More particularly, the string band 22 comprises an elastic band or ring that loops the rear leg member 18 and the top receptacle 20. More particularly, the elastic ring 22 loops the rear leg member 18 and the top receptacle 20 at the central wire leg section and at the midpoint of the V-shaped first circumferential section. In the aforesaid embodiment, where the central wire leg section comprises a loop, the elastic ring 22 is looped thereto so as to ensure that the elastic ring 22 is centrally disposed all the time. The elastic ring 22 abuts the front of the central section (32, FIG. 5) of the hinge rod (base rod) as it extends between the top receptacle 20 and the rear leg member 18. This causes a downward pressure to be exerted over the device 12 by the top receptacle 20 ensuring a tight fit between the device 12 and the adjustable stand 10. The spring-enabled locking device 24 is coupled to the elastic ring 22 for freeing or restricting the loop thereof whereby, the vertical range of the top receptacle 20 is increased or decreased respectively. In an additional embodiment, a suction cup is coupled to the elastic ring 22 particularly between the hinge rod 14 and the rear leg member 18 for securing the stand 10 to a surface so as to hold the stand 10 firmly in place.

In order to use the stand, the stand is moved to a standing position from a collapsed position by angling the bottom receptacle and the rear leg member away from each other to a desired angle. The stand is then placed upright on the front and hind legs. Once there, the bottom edge of the device is snugly received within the bottom receptacle. The top receptacle is then placed over the top edge of the device such that, a snug fit is achieved between the device and the top receptacle. If the reach of the top receptacle is not enough, the loop of the elastic ring is freed by operating the locking device. On the other hand, if the elastic ring is a slack, the loop of the elastic ring is restricted by operating the locking device. As the top and bottom receptacle are made of pliable material, minor adjustments can be made. For example, if a front camera on the device is being blocked, the claw section on the upper receptacle can be bent upwards or downwards so as to make the camera view unobstructed. In another example, the stand can be fitted over the thigh of a user by simply receiving the thigh between the front and rear legs such that, the device is facing the user. Once there, the front are rear legs are pressed towards each other for achieving a snug fit between the thigh and the stand.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. An adjustable support stand for a electronic display device comprising:
(a) a central hinge rod;
(b) a bottom receptacle hingedly coupled to the hinge rod, the bottom receptacle comprising a frame structure made by bending a pliable wire, the bottom receptacle for receiving a bottom edge of the device therewithin, the bottom receptacle being of a U-shape as viewed from side, the U-shape within which, the bottom edge of the device is received;
(c) a rear leg member hingedly coupled to the hinge rod, the rear leg member comprising frame structure made by bending a pliable wire;
(d) a top receptacle for gripping over a top edge of the device, the top receptacle comprising a frame structure made by bending a pliable wire, the top receptacle comprising an inverted U-shape as viewed from side, the inverted U-shape within which, the top edge of the device is received;
(e) a string band for looping together the rear leg member and the top receptacle, the string band abutting the front of the hinge rod as it loops the rear leg member and the top receptacle so that, a vertical downward pressure is exerted by the top receptacle over the device; and
(f) a spring-enabled locking device coupled to the string band for restricting and freeing the loop of the string band.

2. The adjustable stand of claim 1 wherein, the frame structure pertaining to the bottom receptacle is made by:
(a) bending an elongate pliable wire into a U-shape resulting in the formation of a pair of opposing side receptacle wire sections joined at the ends thereof by a central receptacle wire section;
(b) bending a bottom portion of the uprightly held U-shaped wire backwards to forwards till a pair of loops are formed and a portion of the bottom portion, which includes the central receptacle wire section, extends beyond side receptacle wire sections, the portion of the bottom portion that extends beyond the side receptacle wire sections referred to as a projection portion, the projection portion comprising a pair of opposing projection wire sections joined at the ends thereof by the central receptacle wire section, the bottom receptacle to rest on the pair of loops;
(c) bending the pair of projection wire sections upwards so as to form a U-shape between each projection wire section and the corresponding side receptacle section as viewed from side, the bottom edge of the device to be snugly received between the projection and side wire sections as the device is received within the bottom receptacle; and
(d) hingedly coupling the two free opposite ends of the U-shaped wire to the hinge rod.

3. The adjustable stand of claim 2 wherein, the frame structure pertaining to the bottom receptacle is further made by bending the mid portion of the central receptacle wire section downwardly so as to form an M-shape as viewed from front.

4. The adjustable stand of claim 1 wherein, the frame structure pertaining to the rear leg member is made by:
(a) bending an elongate pliable wire into a U-shape resulting in the formation of a pair of opposing side leg wire sections joined at the ends thereof by a central leg wire section; and
(b) hingedly coupling the two free opposite ends of the U-shaped wire to the hinge rod.

5. The adjustable stand of claim 4 wherein, the frame structure pertaining to the leg member is further made by bending, prior to the U-shaped wire being hingedly coupled to the hinge rod, the bottom section of the uprightly U-shaped wire, which comprises the central wire section such that, the bent section of the U-shaped wire and the rest of the U-shaped wire are opposingly disposed forming a U-shape therebetween as viewed from side.

6. The adjustable stand of claim 5 wherein, the mid portion of the central wire section comprises a band ring to which, the string band looped.

7. The adjustable stand of claim 1 wherein, the frame structure pertaining to the top receptacle is made by:
(a) permanently joining the ends of a pliable wire to form a ring;
(b) bending a first circumferential section of the ring at the midpoint thereof to form a planar V-shaped section, the string band stays at the central point of the V-shaped section as it loops the top receptacle; and
(c) bending the remaining second circumferential section about the first circumferential section such that, the first and second circumferential sections are opposingly disposed and form an inverted U-shape as viewed from side; the top edge of the device to be received between the first and second circumferential sections as the top receptacle is received over the device.

8. The adjustable stand of claim 7 wherein, the frame structure pertaining to the top receptacle is further made by bending the midpoint of the second circumferential section upwards such that, a W-shape is formed as viewed from front.

9. The adjustable stand of claim 1 wherein, each of the pliable wires pertaining to the top and bottom receptacles and the rear leg member is received within a tubing prior to being made the respective components, i.e., the top and bottom receptacles and the rear leg member.

10. The adjustable stand of claim 1 wherein, the tubing is made of non-latex rubber.

11. The adjustable stand of claim 1 wherein, the pliable wire comprises galvanized steel wire.

12. The adjustable stand of claim 1 wherein, the string band is elastic.

13. The adjustable stand of claim 1 further comprising a suction cup for securing the adjustable stand to a surface, the suction cup coupled to the string band, the suction cup slidably disposed between the hinge rod and the rear leg member.

14. The adjustable stand of claim 1 wherein, the central hinge rod comprises:
(a) a base rod comprising:
(i) a central section; and
(ii) a pair of hinge sections adjoining either side of the central section such that, the central and the hinge sections share a common central axis, the cross-sectional area of the central section greater than that of the hinge sections, the free end of each hinge section terminating in a threaded portion;
(b) a pair of hinge sleeves, each hinge sleeve configured to snugly and slidably receive a hinge section therewithin, the hinge sleeve comprising a helical compression spring; and
(c) a pair of wing-nuts for engaging the threaded portions whereby, when a wing-nut is tightened or loosened, the distance between two consecutive loops of the corresponding hinge sleeve decreases or increases respectively thereby controlling the angular movement of the rear leg member with respect thereto.

15. An adjustable support stand for a electronic display device comprising:
(a) a central hinge rod;
(b) a bottom receptacle hingedly coupled to the hinge rod, the bottom receptacle for receiving a bottom edge of the device therewithin, the bottom receptacle being of a U-shape as viewed from side, the U-shape within which, the bottom edge of the device is received, the bottom receptacle comprising a frame structure made by:
(i) bending an elongate pliable wire into a U-shape resulting in the formation of a pair of opposing side receptacle wire sections joined at the ends thereof by a central receptacle wire section;
(ii) bending a bottom portion of the uprightly held U-shaped wire backwards to forwards till a pair of loops are formed and a portion of the bottom portion, which includes the central receptacle wire section, extends beyond side receptacle wire sections, the portion of the bottom portion that extends beyond the side receptacle wire sections referred to as a projection portion, the projection portion comprising a pair of opposing projection wire sections joined at the ends thereof by the central receptacle wire section, the bottom receptacle to rest on the pair of loops;
(iii) bending the pair of projection wire sections upwards so as to form a U-shape between each projection wire section and the corresponding side receptacle section as viewed from side, the bottom edge of the device to be snugly received between the projection and side wire sections as the device is received within the bottom receptacle; and
(iv) hingedly coupling the two free opposite ends of the U-shaped wire to the hinge rod;
(c) a rear leg member hingedly coupled to the hinge rod, the rear leg member comprising a frame structure made by:
(i) bending an elongate pliable wire into a U-shape resulting in the formation of a pair of opposing side leg wire sections joined at the ends thereof by a central leg wire section; and
(ii) hingedly coupling the two free opposite ends of the U-shaped wire to the hinge rod;
(d) a top receptacle for gripping over a top edge of the device, the top receptacle being inverted U-shaped as viewed from side, the inverted U-shape within which, the top edge of the device is received, the top receptacle comprising a frame structure made by:
(i) permanently joining the ends of a pliable wire to form a ring;
(ii) bending a first circumferential section of the ring at the midpoint thereof to form a planar V-shaped section, the string band stays at the central point of the V-shaped section as it loops the top receptacle; and
(iii) bending the remaining second circumferential section about the first circumferential section such that, the first and second circumferential sections are opposingly disposed and form an inverted U-shape as viewed from side; the top edge of the device to be received between the first and second circumferential sections as the top receptacle is received over the device;
(e) a string band for looping together the rear leg member and the top receptacle, the string band abutting the front of the hinge rod as it loops the rear leg member and the top receptacle so that, a vertical downward pressure is exerted by the top receptacle over the device; and
(f) a spring-enabled locking device coupled to the string band for restricting and freeing the loop of the string band.
